(19) United States
(12) Patent Application Publication
(10) Pub. No.: US 2021/0103943 A1
(43) Pub. Date: Apr. 8, 2021

(54) HIT OR MISS INSIGHT ANALYSIS

(71) Applicant: Swytchback, Inc, San Mateo, CA (US)

(72) Inventors: Bruce Bower, Menlo Park, CA (US); Cole Patterson, San Francisco, CA (US); Blaine Nye, San Ramon, CA (US)

(21) Appl. No.: 17/029,423

(22) Filed: Sep. 23, 2020

Related U.S. Application Data
(60) Provisional application No. 62/912,282, filed on Oct. 8, 2019.
(60) Provisional application No. 62/913,139, filed on Oct. 9, 2019.

(51) Int. Cl. G06Q 30/02; G06N 20/00; G06Q 30/06

(52) U.S. Cl. CPC G06Q 30/0204; G06Q 30/0643; G06Q 30/0201; G06N 20/00

(57) ABSTRACT

The invention relates to a data processing method and system for advancing in consumer insights analysis, useful in association with at least one store. In one embodiment, this is accomplished by receiving item related data, modeling data, visual representation data of a product/service and their quality or feature information along with benefits. Segmenting each representation data into a plurality of statistical segments based on one or more attributes, the attributes include a set of primary attributes and a set of secondary attributes which are based on product category-specific information and associated image information. Receiving one or more inputs from target profiles to test positive and negative favourability of the segmented attributes by leveraging a geosocial networking application which allows anonymously to swipe to like or dislike or select from a scalar or independent set of response options the segmented data as inputs. Reconfiguring a product/service offering based on favoured segmented attributes to determine similar data elements associated with items that are preferred by the users and are more likely to be purchased or availed by current and future consumers.

### CROSS-REFERENCE TO RELATED APPLICATIONS; BENEFIT CLAIM

This application claims the benefit of Provisional Appln. 62/912,282, filed Oct. 8, 2019 and Provisional Appln. 62/913,139, filed Oct. 9, 2019, the entire contents of which is hereby incorporated by reference as if fully set forth herein, under 35 U.S.C. § 119(e).

### BACKGROUND

### Technical Field

The present invention generally relates to data processing for market research purposes. In particular, it relates to a data processing method for advancing consumer insights analysis.

### Description of the Prior Art

Image processing technology is a valuable contributor for multiple applications in the digital industry. Moreover, data obtained after analysis of images act as a source of valuable information that allows many industries to restructure their operational model as per demand. One of the most essential tools for any industry is advertising through which companies attempt to convince consumers to purchase their products. Advertising takes many forms including in-door and out-door billboards etc. Companies wish to maximize the effectiveness of these advertisements by determining the most effective means by which to deliver that message. Through advertising, messages about the goods and/or services are presented to existing and/or potential consumers. Advertising campaigns present advertising messages in both in-door and out-door environments. In-store advertising at retail stores is becoming an ever-increasing and effective venue for advertising. This could be a result of decreasing viewership of TV commercials or the increasing awareness of the potential effectiveness of in-store advertising at or near the point of purchase. The in-door environment includes leaflets, posters, flyers, pop-up advertisements, and telemarketing. The out-door environment includes marketing messages presented in public spaces such as roadside billboards, kiosks, visual merchandising and merchandising displays.

Data about the feedback received from these advertisements are stored at a variety of locations and in a variety of forms. Data can be commercially relevant when it can be used to answer commercial questions (e.g., how is a product or product line performing in the market vs. its competitors, to what extent is a product or product line being adopted by a particular market segment, etc.). In turn, insight into these and other commercial questions can help one make business decisions intelligently. Moreover, the different types of data being collected may be unrelated and that poses great challenges for any business to make sense out of such data. Further, processing of the data is a great challenge without any underlining architecture as the data being collected is so different depending on the industry.

Therefore, there is a need to provide improved data processing methods and systems that can overcome the shortcomings associated with existing technologies.

### SUMMARY OF THE INVENTION

The inventive concepts presented herein are illustrated in a number of different embodiments, each showing one or more concepts, though it should be understood that, in general, the concepts are not mutually exclusive and may be used in combination even when not so illustrated.

Accordingly, in one aspect of the present invention provides a method for advancing in consumer insights analysis, useful in association with at least one store. The method receives a plurality of item related data from an entity and creates a taxonomy of a plurality of item attributes from the item related data. Further, the method includes segmenting one or more visual representation data received from the entity into a plurality of statistical segments based on one or more data attributes to obtain segmented attributes. The attributes include a set of primary attributes and a set of secondary attributes which are based on product category-specific information and associated image information. The method includes receiving one or more inputs from a plurality of users against the one or more segmented representation data through an electronic user interface leveraging a geosocial networking application to test favourability of the segmented attributes. The favourability is positive or negative and the geosocial networking application allows an anonymous or identified user to swipe to like or dislike the segmented data as inputs. Further, the method includes reconfiguring a product/service offering by the entity based on favoured segmented attributes to determine similar data elements associated with items that are more likely to be purchased.

In another aspect of the present invention is to provide a system including one or more processors and a database including instructions that, when executed by the one or more processors, cause the system to perform operations. Receiving a plurality of item related data from an entity and creating a taxonomy of a plurality of item attributes from the item related data. Further, segmenting one or more visual representation data received from the entity into a plurality of statistical segments based on one or more data attributes to obtain segmented attributes. The attributes include a set of primary attributes and a set of secondary attributes which are based on product category-specific information and associated image information. receiving one or more inputs from a plurality of users against the one or more segmented representation data through an electronic user interface leveraging a geosocial networking application to test favourability of the segmented attributes. The favourability is positive or negative and the geosocial networking application allows anonymously to swipe to like or dislike or select from a scalar or independent set of response options the segmented data as inputs. Further, the method includes reconfiguring a product/service offering by the entity based on favoured segmented attributes to determine similar data elements associated with items that are more likely to be purchased or availed by current and future consumers.

In an embodiment, the method or approach of the present invention provides an impression to execute in-store advertising by knowing the insights of the consumer which will facilitate and improve the advertising activities, leading to improved communication approaches for the consumer and shopper.

To further clarify the advantages and features of the present invention, a more particular description of the invention will be rendered by reference to specific embodiments thereof, which is illustrated in the appended figures. It is appreciated that these figures depict only typical embodiments of the invention and are therefore not to be considered limiting of its scope.

### BRIEF DESCRIPTION OF THE DRAWINGS

The invention will be described and explained with additional specificity and detail with the accompanying figures in which:

FIG. 1 shows a flow chart of a method for advancing in consumer insights analysis, useful in association with at least one store, according to one embodiment of the present system.

FIG. 2 shows a system block diagram of performing the method of FIG. 1, according to one embodiment of the present invention.

FIG. 3 shows an example of primary and secondary attributes of the images which are coded by the system to remove consumer variability and allow for a clean read, according to one embodiment of the present invention.

FIG. 4 shows an example representation of a geosocial networking application that anonymously allows a user to swipe to like or dislike or select from a scalar or independent set of response options the attributed inputs from the target profile, according to one embodiment of the present invention.

FIG. 5 shows an example outcome of the analysis which shows the design and allocation of a higher proportion of Denim Jean CCs with saturated, dark indigo washes, according to one embodiment of the present invention.

FIG. 6A & 6B show an example outcome of the analysis of capturing free text which helps the designers and marketers understand about the choices which are made in consumer's own voices, according to one embodiment of the present invention.

FIG. 7 shows a table of attributes providing design taxonomy for clothing or fashion related entity, according to one embodiment of the present invention.

Further, skilled artisans will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present invention so as not to obscure the figures with details that will be readily apparent to those of ordinary skill in the art having benefit of the description herein.

### DETAILED DESCRIPTION

For the purpose of promoting an understanding of the principles of the invention, reference will now be made to the embodiment illustrated in the figures and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof. The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components. Appearances of the phrase “in an embodiment”, “in another embodiment” and similar language throughout this specification may, but do not necessarily, all refer to the same embodiment.

Unless otherwise defined, all technical and scientific terms used herein have the same meaning as commonly understood by one of ordinary skill in the art to which this invention belongs. The system, methods, and examples provided herein are illustrative only and not intended to be limiting.

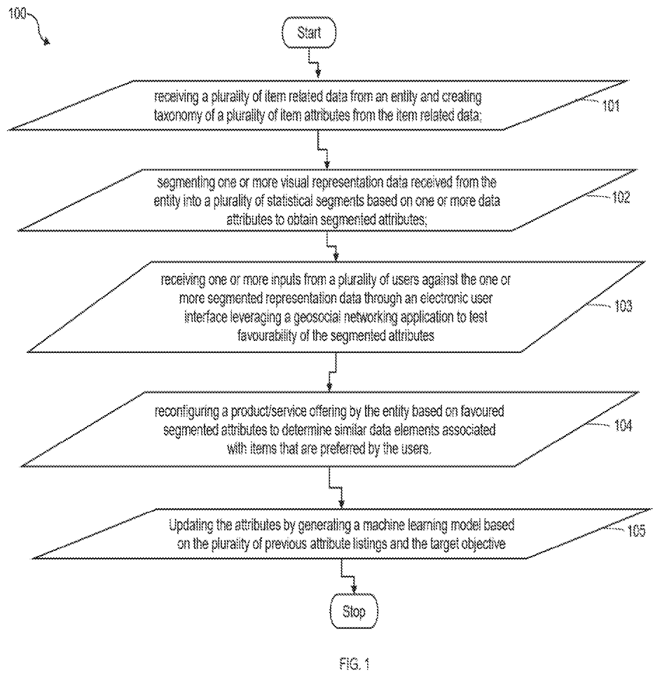

Embodiments of the present invention will be described below in detail with reference to the accompanying figures. Referring to FIG. 1 shows a flow chart 100 of a method for advancing in consumer insights analysis, which may be useful in association with one or more stores.

At step 101, the method receives a plurality of item related data from an entity and creates a taxonomy of a plurality of item attributes from the item related data. Further, modeling data is received from the entity, the modeling data includes visual representation data of a product/service and their quality or feature information along with benefits. The visual representation includes images contained styles, ensembles, products, and accessories stylized in a variety of sets and settings.

At step 102, the method segments each representation data into a plurality of statistical segments based on one or more attributes, the attributes include a set of primary attributes and a set of secondary attributes which are based on product category-specific information and associated image information. The segmented attributes of the representation data is to remove consumer variability, where the segmented attributes are based out of data sets, the data sets with similar values are defined as primary attributes and the data sets that have values that are spread out defined as secondary attributes. In an example embodiment, the statistical segments of the representation data may be classified through a taxonomy, in which the hierarchy of categories is fixed, the classified taxonomy is to create user-specific design taxonomy which is based on the attributes. The primary attributes provide product category-specific information to apprise concepts and merchandising decisions, and the secondary attributes provide image information to apprise product photography and facilitate clean read on product decisions. In particular, the primary and secondary attributes include consumer insight data.

At step 103, the method receives one or more inputs from users/target profiles to test positive and negative favourability of the segmented attributes by leveraging a geosocial networking application which allows anonymously to swipe to like or dislike the segmented data as inputs. In an example embodiment, the target profiles include consumers of the store, general social networking consumers, and any consumer who have interest in-store product or service. By way of receiving free text inputs from target profiles using the geosocial networking, the application facilitates the designers and marketers to understand the choices of the consumer which are made in their own voices.

At step 104, the method reconfigures a product/service offering by the entity based on favoured segmented attributes to determine similar data elements associated with an item that is more likely to be purchased or availed by current and future consumers. In an example embodiment, the adjusting offering includes design and allocate a higher proportion of most preferred products. Further, the offering of the product/service includes reframing in-store and online photography to showcase product selection, and consumers favoured stylized outdoor product photos over studio photos, etc. Further, adjusting offering suggestions may include the design and allocation of a higher proportion of the product/service at the store.

At step 105, the method updates the attributes by assessing primary and secondary attributes which identify the features or functions that drive and enhance market value, where the attributes are updated by generating a machine learning model based on the plurality of previous attribute listings and the target objective, in addition free response data is analyzed here using natural language processing and natural language understanding techniques to identify relevance and effectiveness of existing attributes as well as suggest new attributes that heretofore were unknown. Responses also refine existing attributes and create new more effective attributes. In an example embodiment, an AI engine uses the item attributes to understand the common elements of the highest-rated items are so as to recommend those elements to the system. Example elements can be of design-based (colors, patterns, fit, etc.) or environment-based (rural, urban setting, inside, kitchen, etc.), The AI engine is configured to dynamically generate data models for predicting item attributes and model attributes that determine the favourability of items by consumers. Further, the AI engine may also screen for model attributes (ethnicity, age, gender, hair color, etc). The AI engine not only allows the system to understand which models are most appealing or index against the intent to purchase, it also allows the system to screen out the effect of a model (positive or negative) on the data, which gives us a “clean read”. The expression of the model and the perception of a user providing his/her insight is predicted through the AI engine and then it is processed with the attributes data related to the product of the entity. The AI engine enables identification of appealing item attributes by processing of distinct type of data through an AI-based prediction algorithm.

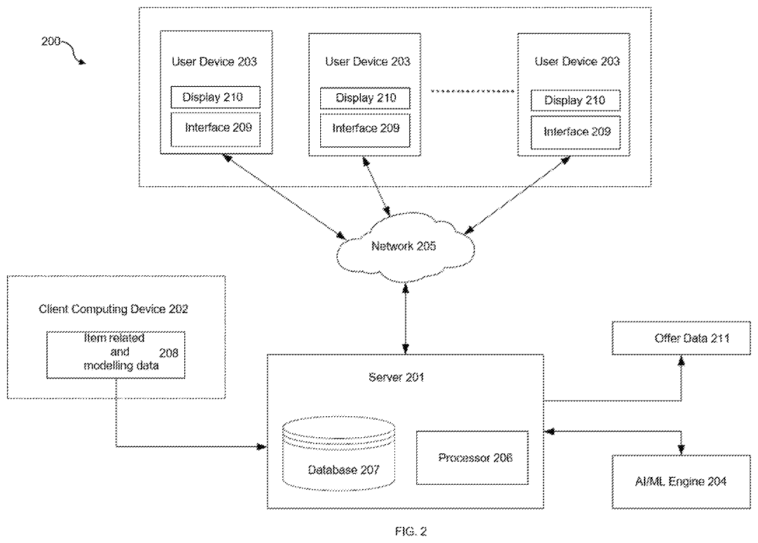

Referring to FIG. 2, shows a system block diagram 200 of the present invention implementing the method of FIG. 1, according to one embodiment of the present invention. The system 200 includes a server (201), a client computing device (202), a plurality of user devices (203), an Artificial Intelligence/Machine Learning Engine (204) which are interconnected over a network (205). The server (201) may include a processor (206) coupled to the AI engine (204) and a database (207), the client computing device (202) may include one or more item related data and modeling data (208), the user device (203) may include an interface (209) and a display (210).

The client computing device (202) or the user device (203) may be a desktop computer, laptop computer, netbook computer, tablet computer, personal digital assistant (PDA), or smart-phone. In general, a client computing device may be any electronic device or computing system capable of sending and receiving data to communicate with the server over the network. The client computing device contains a user interface (UI). In one embodiment, the client computing device/user device represents a personal computer that may be used to access the network. Alternatively, a client computing device/user device may be representative of a cellular telephone, an electronic notebook, a laptop, a personal digital assistant (PDA), or any other suitable device (wireless or otherwise: some of which can perform web browsing), component, or element capable of accessing one or more elements within the system. The client computing device/user device includes an Interface, which may be provided in conjunction with the items listed above, may further comprise any suitable interface for a human user such as a video camera, a microphone, a keyboard, a mouse, or any other appropriate equipment according to particular configurations and arrangements. In addition, the interface may be a unique element designed specifically for communications involving the system. Further, the client computing device/user device includes ad display, in one embodiment, is a computer monitor or a mobile screen of a smartphone. Alternatively, the display may be any device which allows user to appreciate information that the system transmits.

The server (201) may be a management server, a web server, or any other electronic device or computing system capable of sending and receiving data. In some embodiments, the server may be a laptop computer, tablet computer, netbook computer, personal computer (PC), a desktop computer a personal digital assistant (PDA), a smartphone, or any programmable electronic device capable of communicating with other client computing device and/or other servers via a network. In other embodiments, server may represent a server computing system utilizing multiple computers as a server system, such as in a cloud computing environment. Server may be an enterprise server capable of providing any number of a variety of services to large number of users.

The server may include software and/or algorithms to achieve the operations for processing, communicating, delivering, gathering, uploading, maintaining, and/or generally managing data, etc. Alternatively, such operations and techniques may be achieved by any suitable hardware, component, device, application specific integrated circuit (ASIC), additional software, field programmable gate array (FPGA), server, processor, algorithm, erasable programmable ROM (EPROM), electrically erasable programmable ROM (EEPROM), or any other suitable object that is operable to facilitate such operations. The server allows a user to take advantage or avail of the services provided by the server. The server may accept any of the enterprise services to provide services to users attempting to access the server. The nature of the services represented by enterprise services depends upon the services provided by the server. In one embodiment, the server may be an online retailer server, and enterprise services may include consumer insights analysis which may be useful in association with stores.

Network (205) may be a local area network (LAN), a wide area network (WAN) such as the Internet, a cellular data network, any combination thereof, or any combination of connections and protocols that will support communication between a client computing device, and the server, in accordance with embodiments of the invention. Network may include wired, wireless, or fiber-optic connections. Computing system may include additional computing devices, servers, computers, or other devices not shown.

The system further includes an Artificial Intelligence/Machine Learning (AI/ML) Engine (204). The role of AI/ML is to capture the essence of a stimuli through image processing/analysis, NLP/NLU of free responses and the attributes. As the stimuli is experienced by users, these three pillars will provide clarity into the truth underlying the stimuli. The AI/ML engine interacts with the server for facilitating feedback of the target profiles in a network environment. The feedback of the target profile provided by the AI/ML engine may include the learning of the previous interaction with the server and suggest a plurality of parameters which may be useful in determining the objective.

In an embodiment, the essence of the stimuli through the image processing analysis includes prediction logic for generating at least one identifier of the stimuli based on the determined user response. This can be accomplished by associating the determined responses user response with a timeframe recording the beginning and end of the response period. A collection of one or more such responses giving the user grouping, the start time, the end time and the nature of response may then be used to identify the stimuli by synchronizing the timeframe with the time at which the stimuli began being viewed by the user. The identifier generation logic includes logic for indexing the identifier(s) based on the determined user response(s). This is just the process of maintaining a two-way linkage between the original stimulus and the annotations, so that the annotation quadruples above are augmented with a link to the relevant stimulus. These may be stored according to any standard database methodology, preferably enabling queries such as “all stimuli portions that provoked a response of 5 seconds or more of joy”.

Various embodiments disclosed herein provide numerous advantages by providing a method and system for providing data insights based on artificial intelligence. The present invention uses an AI/ML engine to determine data insights, both simple and complex, based on artificial intelligence. The present invention is of both analytics tool and data scientist(s) to provide data insights to an end user based on learnings of previous data processing. The present invention is operational at all times and further provides the data insights in question-answer format making it easier for the present invention thereby allowing reduction in time spent by management(s) during decision making, and procuring data at a right time.

In an exemplary embodiment, the invention provides an AI (Artificial Intelligence) based data processing method for user insight analysis. The method includes receiving item related data from an entity, creating a taxonomy of a plurality of item attributes from the item related data, receiving one or more inputs from a plurality of target profiles/users against at least one image through an electronic user interface wherein the image includes a plurality of data elements. Based on inputs from the target profiles/users, identifying items for recommendation. The AI engine uses the item attributes to understand what the common data elements of the highest-rated items are to recommend those elements. These elements can be design-based (colors, patterns, fit, etc.) or environment-based (rural, urban setting, inside, kitchen, etc.). The AI engine is also configured to screen for model attributes (ethnicity, age, gender, hair color, etc., of the model appearing in the image). This not only allows the entity to understand which models are most appealing or index against the intent to purchase, it also allows the system to screen out the effect of a model (positive or negative) on the data, which gives a “clean read”.

In addition to the above, free text responses are collected from the target profiles/users through the interface. The response may include information such as why the user(s) voted the way they did, thereby providing significantly improved direction. The AI engine analyzes the free text responses based on natural language processing (NLP) for better understanding the user(s)/respondent(s) sentiment across all the items and their attributes.

In an embodiment, the free text responses are configured to be attributes themselves, thereby enabling parsing of the same elements based on the words/phrases used and frequency of use.

In an operation, the system receives item related data and modeling data (208) which is provided by the client design and one or more concepting teams. These items related data and modeling data (208) include concept boards which are visual representation data of a product/item/service and their quality or feature information along with benefits. These inputs are received by the server (201) which includes the processor (206) and the database (207). The processor (206) of the server, attribute codes each image to code for key design factors and remove variances due to stylization so that client can zero in on product feedback. In particular, the processor (206) segments each representation data into a plurality of statistical segments based on one or more attributes. The attributes may include primary attributes and secondary attributes which are based on product category-specific information and associated image information. Further, the processor (206) of the system influence a geosocial networking application. The application is to receive one or more inputs from target profiles to test positive and negative favourability of the segmented attributes. In an example embodiment, the application includes a segmented attribute and allows the user on his/her user device (203) to select “Like” or “Dislike” to test the design concepts. The target profiles may be a client's best consumers and may include other potential consumers. The test measures feedback from a group of consumers over the network helps the design teams in adjusting offerings that may be more likely to be purchased by current and future consumers. For each offering, the server keeps updating the data in the database. An artificial intelligence/machine learning (AI/ML) engine (204) configured with the server (201) to send at least part of the first information from an output of the system to an input of the system by updating the attributes which identify the features or functions which drive and enhance market value. The updating of the attributes by generating a machine learning model based on the plurality of previous attribute listings and the target objective.

In an example embodiment, if the result of the whole process comes out to be as an offer data (211) i.e. consumers prefer imagery and assortments with dark wash denim and warm light-colored blouses. Based on the same, reframe in-store and online photography to showcase our dark wash denim selection. Dark wash conveys elevation to the consumer. Further, consumers favored stylized outdoor product photos over studio photos. Furthermore, skew towards warm-colored blouses and ensure a representative amount of these types of blouses are in the women's assortment.

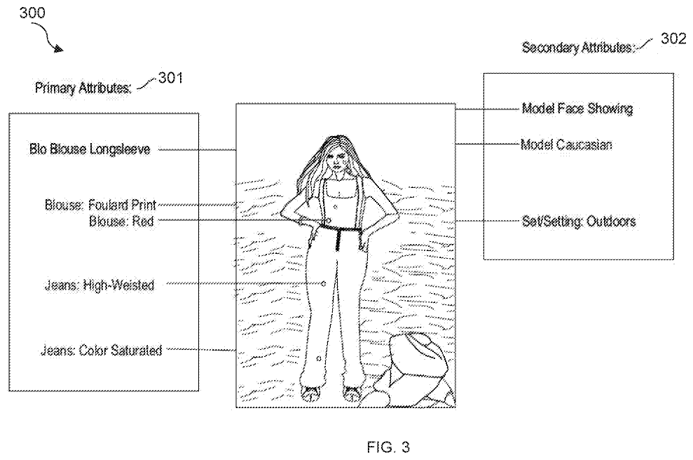

FIG. 3 shows an example of primary (301) and secondary (302) attributes of the example images (300) which are coded by the system in order to remove consumer variability and allow for a clean read, according to one embodiment of the present invention. In an example embodiment, the primary attributes (301) provide product/item category-specific information to inform concepting and merchandising decisions. The primary attributes may include Blo Blouse: Longsleeve, Blouse: Foulard Print, Blouse: Red, Jeans: High-Waisted, and Jeans: Color saturated. And, the secondary attributes (302) provides image information to inform product photography & facilitate clean read on product decisions. The secondary attributes may include Model: face showing; Model: Caucasian and Set/setting: Outdoors.

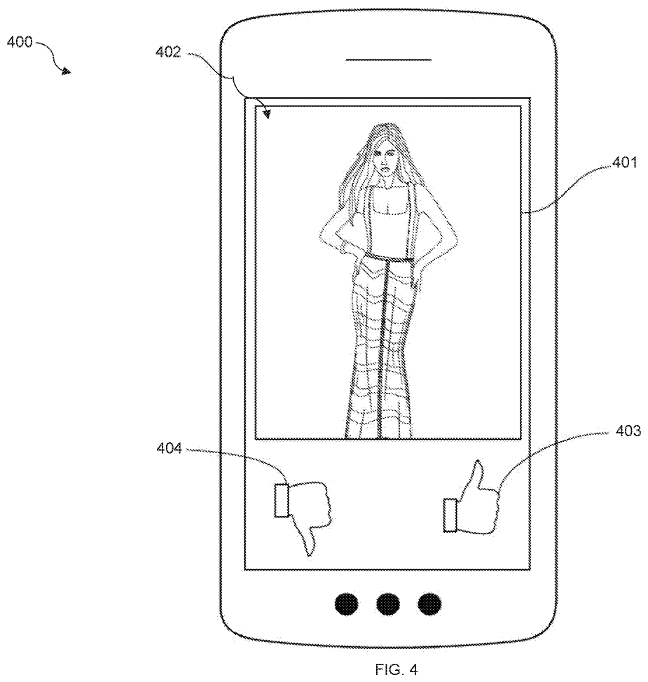

FIG. 4 shows an example representation of geosocial networking application which will allow anonymously to swipe to like or dislike the attributed inputs from the target profile. As shown in FIG. 4, the presentation of the image is depicted as occurring through the display of a user device (400). In this embodiment, a plurality of attributed inputs (one or more images) (401) is presented to the user. The user device (400) which includes a display (402) may show one or more image of the segmented attribute profiles for which user has to view the displayed information on his/her device and provide inputs as like (403) or dislike (404) by swiping on left or right. User(s) may also be presented with a summary of information regarding suggested attributed images. The summary may include one or more of: a picture, name, picture information, gender, or other profile information etc. Expressing approval or disapproval by swiping left or right i.e. like or dislike, the user is providing his inputs to the server and the same is processed and updated at the database.

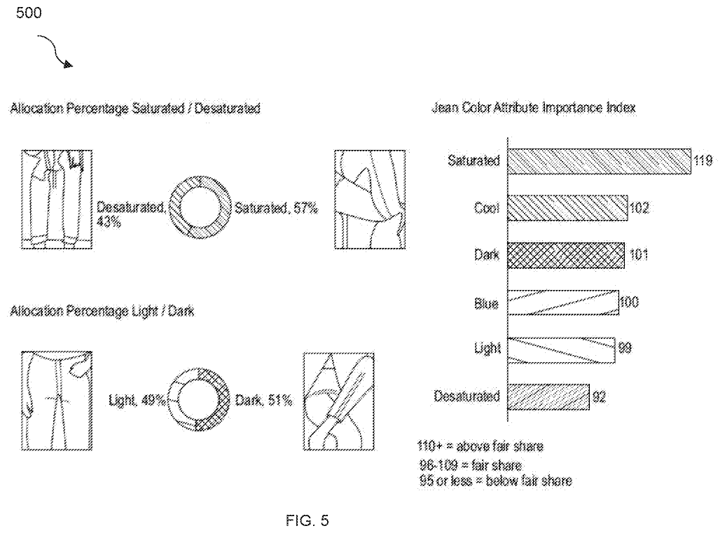

FIG. 5 shows an example outcome (500) of the analysis which shows the design and allocation of a higher proportion of specific product(s), according to one embodiment of the present invention. In an example, if the output of the processed information may be considered as a result of the system i.e. Results: Jean washes with Saturated Color are most preferred. The figure shows, how allocation percentage saturated/desaturated is provided as a result. In this present example, the saturated results are 57% and the desaturated result is 43%. Similarly, allocation percentage of light or dark, as a result it shows the dark is 51% and the light is 49%. Moreover, the result may also include color attribute importance index. Eg. Jean Color. Between the saturated and the desaturated, there are various option which are opted by the user. For example, in Jean the option includes cool, dark, blue, light etc. Based on the result of the above analysis, the system suggests the storekeeper keep denim Jean CCs with saturated, dark indigo washes with up stock as the consumer insights are intended to buy this product.

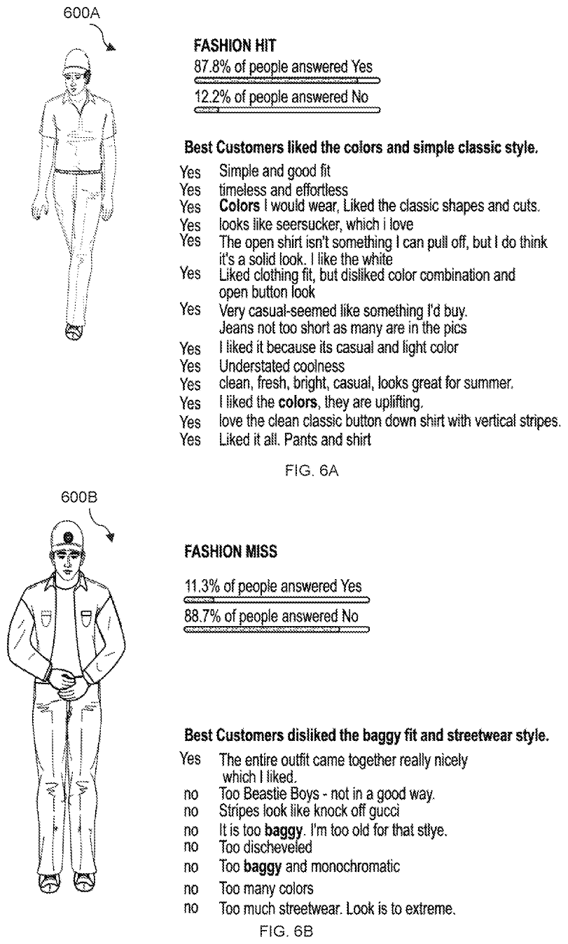

FIG. 6A & 6B shows example outcome (600A) and (600B) of the analysis of capturing free text which helps the designers and marketers understand about the choices which are made in consumers' own voices. For example, if the fashion HIT based on the liked received from the target profiles. For each image, the analysis percentage is declared based on how many people have answered ‘YES’ and ‘NO’ on each image shown. For example, the best consumers liked the colors and simple classic style. They opted for ‘YES’ based on “simple and good fit”, timeless and effortless, colors I would wear. Liked the classic shapes and cuts, looks like seersucker, which I love, the open shirt isn't something I can pull off, but I do think it's a solid look. I like the white, liked clothing fit, but disliked color combination and open button look, very casual-seemed like something I'd buy. Jeans not too short as many are in the pics, I like it because its casual and light color, understated coolness, clean-fresh-bright-casual-looks great for summer, I liked the colors, they are so uplifting, love the clean classic button down shirt with vertical stripes, liked it all—Pants and shirt. For example, if the fashion “MISS” i.e. best Consumers disliked the baggy fit and streetwear style based on the entire outfit came together really nicely which I liked, too Beastie Boys—not in a good way, stripes look like knock off Gucci, It is too baggy. I'm too old for that style, too dishevelled, too baggy and monochromatic, too many colors, too much streetwear. Look is too extreme.

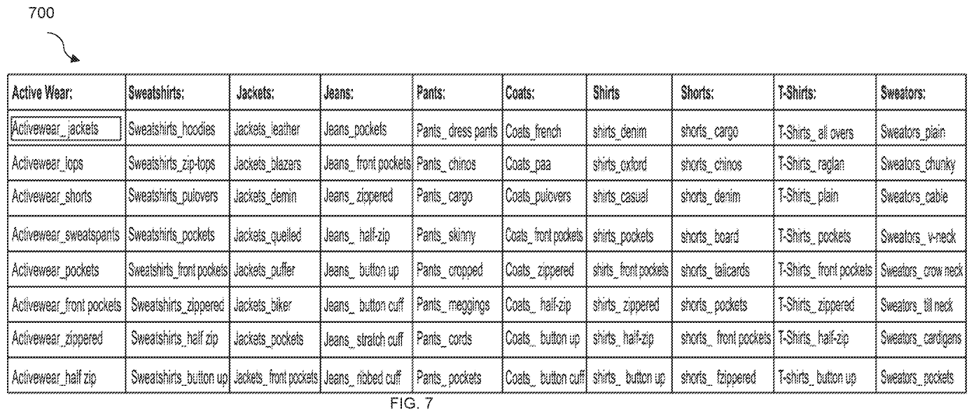

In an exemplary embodiment, the system of the present invention creates entity-specific design taxonomy with primary and secondary attributes listed as shown in table 700 of FIG. 7. Some of the taxonomy for a clothing or fashion category includes activewear, sweatshirt, Jackets, Jeans, Pants, coats, shirts, shorts, T-shirts, Sweaters, etc. The table includes sub-elements under each category to create a comprehensive list of attributes. The AI-based data processing of these attributes along with inputs received from a user through an application interface, enables prediction of preferred items for consumers at large, thereby enabling the entity to take informed decision through the AI-based insights analysis.

While the invention has been described with an example of a fashion retail application, it shall be apparent to a person skilled in the art the various other application(s) may utilize the data processing method and system of the invention. In an advantageous aspect, the method and system of the present invention are utilized for the testing image quality of images uploaded to an online furniture retailer entity. Also, testing for understanding nutritional elements of meal images uploaded to a nutritional application. The system and method enable the creation of consumer sentiment maps for a fashion retailer. Also, it analyzes changes in sentiment for financial service consumers post a pandemic, where questions are attribute coded for underlying concerns, e.g. liquidity, lifestyle change, etc.

While specific language has been used to describe the disclosure, any limitations arising on account of the same are not intended. As would be apparent to a person in the art, various working modifications may be made to the method to implement the inventive concept as taught herein.

The figures and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the appended claims.

What is claimed is:

1. A data processing method for user insights analysis, the method comprising:
receiving a plurality of item related data from an entity and creating a taxonomy of a plurality of item attributes from the item related data;
segmenting one or more visual representation data received from the entity into a plurality of statistical segments based on one or more data attributes to obtain segmented attributes;
receiving one or more inputs from a plurality of users against the one or more segmented representation data through an electronic user interface leveraging a geosocial networking application to test favourability of the segmented attributes;
and
reconfiguring a product/service offering by the entity based on favoured segmented attributes to determine similar data elements associated with items that are preferred by the users.

2. The method of claim 1, wherein the visual representation includes images contained styles, ensembles, products, and accessories stylized in a variety of sets and settings.

3. The method of claim 2 wherein the attributes include a set of primary attributes and a set of secondary attributes which are based on product category-specific information and associated image information.

4. The method of claim 2, wherein the primary attributes provide product category-specific information to apprise concepting and merchandising decisioning, and the secondary attributes provide image information to apprise product photography and facilitate clean read on product decisioning.

5. The method of claim 3, wherein the segmented attributes of the representation data is to remove consumer variability, where the segmented attributes are based out of data sets, the data sets with similar values are defined as primary attributes and the data sets that have values that are spread out are defined as secondary attributes.

6. The method of claim 1, wherein statistical segments of the representation data are generated through the taxonomy, in which the hierarchy of categories is fixed, the taxonomy is user specific design taxonomy which is based on the data attributes.

7. The method of claim 3, wherein the primary and secondary attributes includes consumer insight data.

8. The method of claim 1, wherein reconfiguring the product/service offering includes reframing in store and online photography to showcase product selection, and consumers favoured stylized outdoor product photos over studio photos.

9. The method of claim 1, wherein reconfiguring the offering includes design and allocate a higher proportion of most preferred products.

10. The method of claim 1, wherein the target profiles/users include consumers of the entity, general social networking consumers, and any consumer who have the intent or interest in store product or service.

11. The method of claim 1, further comprises receiving free text inputs from users/target profiles using the geosocial networking application to facilitate the designers and marketers to understand choices of user(s) which are made in their own voices.

12. The method of claim 3, further comprising:
updating of the data attributes by assessing primary and secondary attributes that identify the features or functions which drive and enhance market value, wherein the updating of the attributes by generating a machine learning model based on a plurality of previous attribute listings and a target objective.

13. The method of claim 12, wherein updating of the attributes by an AI engine which uses the item attributes to understand common features of highest rated items to recommend those features, wherein the features are a design-based feature or environment-based feature.

14. The method of claim 13, wherein the AI engine screens for model attributes including ethnicity, age, gender, hair color etc. which allows to understand most appealing or index against an intent to purchase, and also to screen out positive or negative on the data, to provide a “clean read”.

15. A system, comprising:
one or more processors; and
a database including instructions that, when executed by the one or more processors, cause the system to perform operations comprising:
receiving a plurality of item related data from an entity and creating a taxonomy of a plurality of item attributes from the item related data;
segmenting one or more visual representation data received from the entity into a plurality of statistical segments based on one or more data attributes to obtain segmented attributes;
receiving one or more inputs from a plurality of users against the one or more segmented representation data through an electronic user interface leveraging a geosocial networking application to test favourability of the segmented attributes;
and
reconfiguring a product/service offering by the entity based on favoured segmented attributes to determine similar data elements associated with items that are preferred by the users.

16. The system of claim 15, further comprising:
a feedback AI/ML engine configured to send at least part of a first information from an output of the system to an input of the system by updating the attributes which identify the features or functions which drive and enhance market value, wherein the updating of the attributes by generating a machine learning model based on a plurality of previous attribute listings and a target objective.
